(19) United States
(12) Patent Application Publication
(10) Pub. No.: US 2016/0105237 A1
(43) Pub. Date: Apr. 14, 2016

(54) BI-DIRECTIONAL TRAFFIC ACCESS POINT

(71) Applicant: Virtual Instruments Corporation, San Jose, CA (US)

(72) Inventors: Chi-Luen Wang, Pleasanton, CA (US); Rama Vuppuladhadium, San Jose, CA (US); Jeff Chung, Sunnyvale, CA (US)

(21) Appl. No.: 14/878,851

(22) Filed: Oct. 8, 2015

Related U.S. Application Data
(60) Provisional application No. 62/063,313, filed on Oct. 13, 2014.

(51) Int. Cl. H04B 10/25; H04B 10/2581

(52) U.S. Cl. CPC H04B 10/2503; H04B 10/2581

(57) ABSTRACT

When a bi-directional TAP receives via a first multimode bi-directional fiber a signal transmitted by a storage array to a server, a collimator collimates the light of the signal towards a splitter. The splitter splits the signal into two portions. One portion is output to a second multimode bi-directional fiber connected to the server and the other portion is output to a monitoring system for analysis. When the bi-directional TAP receives via the second fiber a signal transmitted by the server to the storage array, the collimator collimates the light of the signal towards the splitter. The splitter splits the signal into two portions. One portion is output to the first fiber so that it can be received by the storage array. The other portion is output to the monitoring system. The bi-directional TAP can be a reflective or a transmitted type of TAP.

### CROSS REFERENCE TO RELATED APPLICATION

This application claims the benefit of U.S. Provisional Application No. 62/063,313, filed Oct. 13, 2014, which is incorporated by reference herein in its entirety.

### BACKGROUND

1. Technical Field

The described embodiments pertain in general to fiber optics, and more specifically to a bi-directional traffic access point (TAP).

2. Description of Related Art

As network connections in datacenters are on the rise, there is a need to gain better visibility of networks in order to improve optical performance and the security of data being exchanged. One way of gaining visibility into a network is using a traffic accesses point (TAP). A TAP is a device that diverts at least a portion of signals being exchanged between systems (e.g., between a server and a storage array) for monitoring the data and the infrastructure performance of the network.

Conventionally, TAPs are uni-directional in that they use a pair of couplers for simultaneously diverting signals being exchanged between two systems. For example, in a storage area network (SAN) where signals between a server and a storage array are monitored, one coupler is dedicated to diverting a portion of signals transmitted by the storage array to the server (the upstream signals). Another coupler is dedicated to diverting a portion of signals transmitted by the server to the storage array (the downstream signals). Hence, in a uni-directional TAP one coupler is needed for each direction. Because of the uni-directional nature of TAPs, as fiber density increases in a network, coupler density in a TAP increases at double the rate.

### SUMMARY

The described embodiments provide a bi-directional traffic access point (TAP). When the bi-directional TAP receives via a first multimode bi-directional fiber a signal transmitted by a storage array to a server, a collimator collimates the light of the signal towards a splitter. The splitter splits the signal into two portions. One portion is output to a second multimode bi-directional fiber connected to the server and the other portion is output to a monitoring system for analysis.

When the bi-directional TAP receives via the second multimode bi-directional fiber a signal transmitted by the server to the storage array, the collimator collimates the light of the signal towards the same splitter. The splitter splits the signal into two portions. One portion is output to the first multimode bi-directional fiber so that it can be received by the storage array. The second portion is output to the monitoring system as a separate output channel.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates a bi-directional traffic access point (TAP) in a storage area network (SAN) according to one embodiment.

FIG. 2 illustrates terminations of the bi-directional TAP according to one embodiment.

FIG. 3 illustrates a side view inside of the bi-directional TAP according to one embodiment.

FIG. 4 illustrates two plots of bit error rate (BER) rate as a function of received power for the bi-directional TAP and a un-directional TAP according to one embodiment.

FIG. 5 illustrates bit error results of running the bi-directional TAP for twenty two hours according to one embodiment.

FIG. 6 illustrates terminations of a bi-directional TAP according to another embodiment.

FIG. 7 illustrates a side view inside of the bi-directional TAP according to the embodiment of FIG. 6.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “112A,” indicates that the text refers specifically to the element having that particular reference numeral. A reference numeral in the text without a following letter, such as “112,” refers to any or all of the elements in the figures bearing that reference numeral (e.g. “112” in the text refers to reference numerals “112A,” “112B,” and/or “112C” in the figures).

### DETAILED DESCRIPTION

A traffic access point (TAP) is a hardware device inserted in a network, where the TAP diverts a portion of signals being exchanged between the systems of the network. These diverted signals give insight into the true performance, health and utilization of a network. By obtaining information about the performance of a network, system-wide latency can be reduced, network outages can be prevented, and resource utilization can be dramatically improved.

Traditionally a TAP is uni-directional, meaning that the TAP includes at least two couplers for monitoring signals exchanged between a first system and a second system in a network. One coupler is dedicated to diverting signals transmitted by the first system and the other coupler is dedicated to diverting signals transmitted by the second system.

Described herein is a bi-directional TAP (also referred to as a bi-directional coupler) for use in multi-mode applications. The bi-directional TAP can be used for data monitoring (e.g., analyzing alternating current (AC) data signals) and power monitoring (e.g., analyzing direct current signals). Unlike the uni-directional TAP, with the bi-directional TAP a single coupler is used for bi-directional communications. Hence, the same coupler diverts signals transmitted by the first system and signals transmitted by the second system. Since with a bi-directional TAP a single coupler is used for signals of both directions, the coupler density is cut in half compared to a uni-directional TAP.

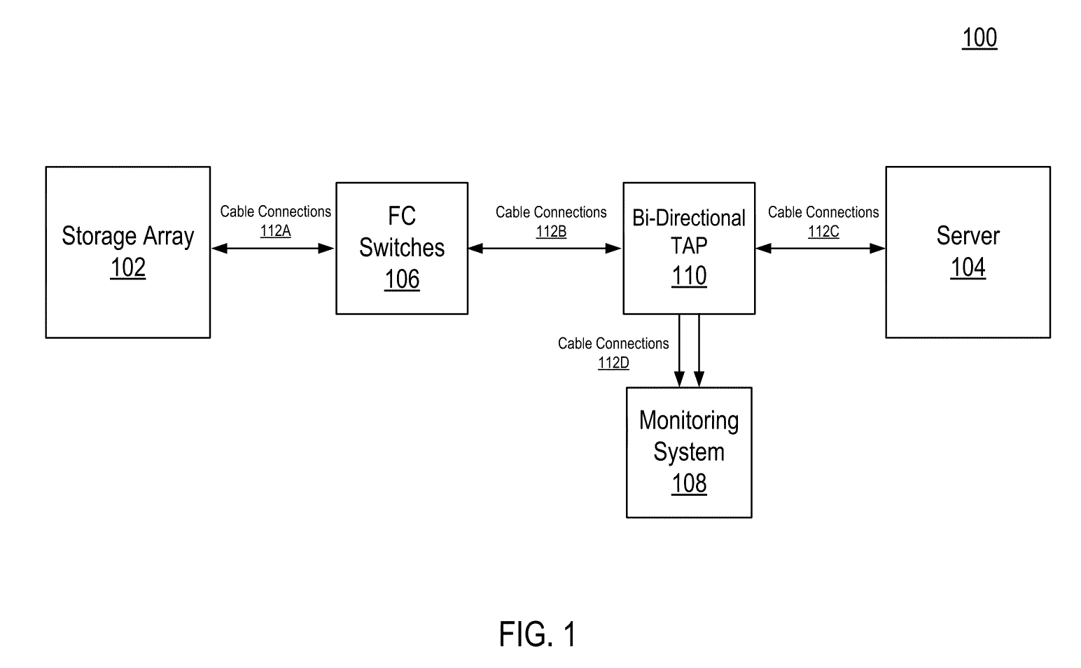

FIG. 1 illustrates a bi-directional TAP 110 in a storage area network (SAN) 110 according to one embodiment. The SAN 100 includes a storage array 102, a server 104, fibre channel (FC) switches 106, a monitoring system 108, and the bi-directional TAP 110. Although the illustrated SAN 100 includes a limited number of each entity, it should be understood that in other embodiments the SAN 100 can include more of each entity (e.g., additional storage arrays 102 and servers 104) and additional components (e.g., fiber patch panels) with various connectors.

The storage array 102 is a storage system that stores data. When the storage array 102 receives a request from the server 104 to store data, the storage array 102 stores the data according to the request. When the storage array 102 receives a request from the server 104 for stored data, the storage array 102 retrieves the requested data and transmits it to the server 104. The storage array 102 is connected to the FC switches 106 via cable connections 112A.

The FC switches 106 are network switches compatible with the FC protocol. The FC switches 106 connect the storage array 102 to the server 104 by receiving, processing, and forwarding data exchanged between the storage array 102 and the server 104. The FC switches 106 are connected to the bi-directional TAP 110 via cable connections 112B. Connectors of cable connections could be, for example, LC to LC or LC to MPO depending on the environment.

The server 104 is a computing system that has access to the storage capabilities of the storage array 102. The server 104 may provide data to the storage array 102 for storage and may retrieve stored data from the storage array 102. The server 104 is connected to the bi-directional TAP 110 via cable connections 112C.

The monitoring system 108 receives signals diverted by the bi-directional TAP 110. In one embodiment, the monitoring system 108 is the VirtualWisdom SAN Performance Probe provided by Virtual Instruments Corporation of San Jose, Calif. The monitoring system 108 analyzes the signals diverted by the bi-directional TAP 110 and based on the signals generates data about the SAN 100. For example, the generated data may include: data transmission rates, read exchange completion times, write exchange completion times, and average input output operations per second. The monitoring system 108 is connected to the bi-directional TAP 110 via cable connections 112D.

The bi-directional TAP 110 receives signals exchanged between the storage array 102 and the server 104 and diverts a portion of the signals exchanged in each direction to the monitoring system 108. As described above, the bi-directional TAP 110 is connected to the FC switches 106 via cable connections 112B, to the server 104 via cable connections 112C, and to the monitoring system 108 via cable connections 112D. The cable connections 112B and 112C are multimode fiber optic bi-directional cable connections. Since the cable connections 112B and 112C are bi-directional, it means that a single fiber of a connection can carry downstream and upstream signals (signals transmitted by the storage array 102 and signals transmitted by the server 104). For a single fiber to carry signals in both directions, the downstream and upstream signals are made to pass each other in opposite directions using two different wavelengths. In one embodiment, cable connections 112D are multimode fiber optic uni-directional cable connections. In this embodiment, the fibers of the connections 112D carry signals in one direction. The cable connections 112A, 112B, and 112C are bi-directional connections.

The bi-directional TAP 110 receives signals transmitted by the storage array 102 and destined for the server 104 (also referred to as downstream signals). The bi-directional TAP 100 receives the downstream signals via the bi-directional cable connections 112B. When the TAP 110 receives a downstream signal via a bi-directional fiber of the cable connections 112B, the TAP 110 splits the downstream signal into two portions. The split may be, for example, approximately a 70/30 or an 80/20 split. The bi-directional TAP 110 outputs one portion of the downstream signal (e.g., 70% of the light) to the server 104 via a bi-directional fiber of cable connections 112C. The remaining portion of the signal (e.g., 30% of the light) is output to the monitoring system 108 via uni-directional cable connections 112D.

The bi-directional TAP 110 also receives signals transmitted by the server 104 and destined for the storage array 102 (also referred to as upstream signals) via bi-directional cable connections 112C. When the TAP 110 receives an upstream signal via a bi-directional fiber of the cable connections 112C, the TAP 110 splits the upstream signal and outputs one portion of the signal (e.g., 70% of the light) to the FC switches 106 via a bi-directional fiber of cable connections 112B. The remaining portion of the signal (e.g., 30% of the light) is output to the monitoring system 108 via uni-directional cable connections 112D. Hence, both upstream and downstream signals can be simultaneously processed by the bi-directional TAP 110 without the need for multiple couplers.

Although the bi-directional TAP 110 is described herein as operating in a SAN 110 environment, it should be understood that the bi-directional TAP 110 can be used in other environments to monitor power signals exchanged between systems of a network (e.g., where monitored side is 5% or less of power of a signal).

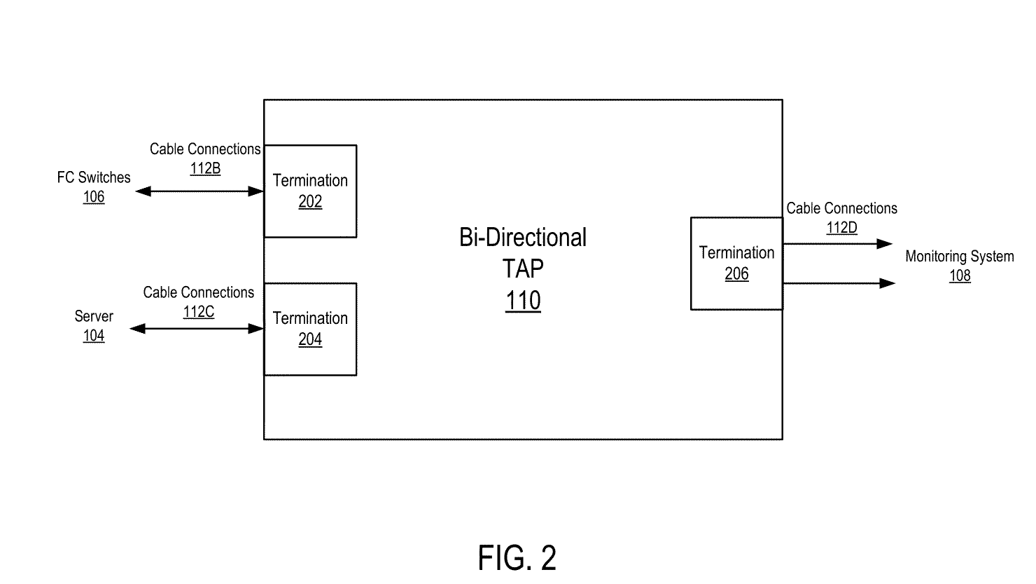

FIG. 2 illustrates at least three terminations 202, 204, and 206 of the bi-directional TAP 110. The terminations 202, 204, and 206 allow cable connections to connect to the bi-directional TAP 110. In one embodiment, termination 204 is a multimode Lucent Connector (LC) termination and terminations 202 and 206 are multimode LC or multiple-fiber push-on (MPO) terminations. One or more bi-directional fibers of cable connections 112B connect to termination 202 and one or more bi-directional fibers of cable connections 112C connect to termination 204. Additionally, un-directional fibers of cable connections 112D connect to termination 206.

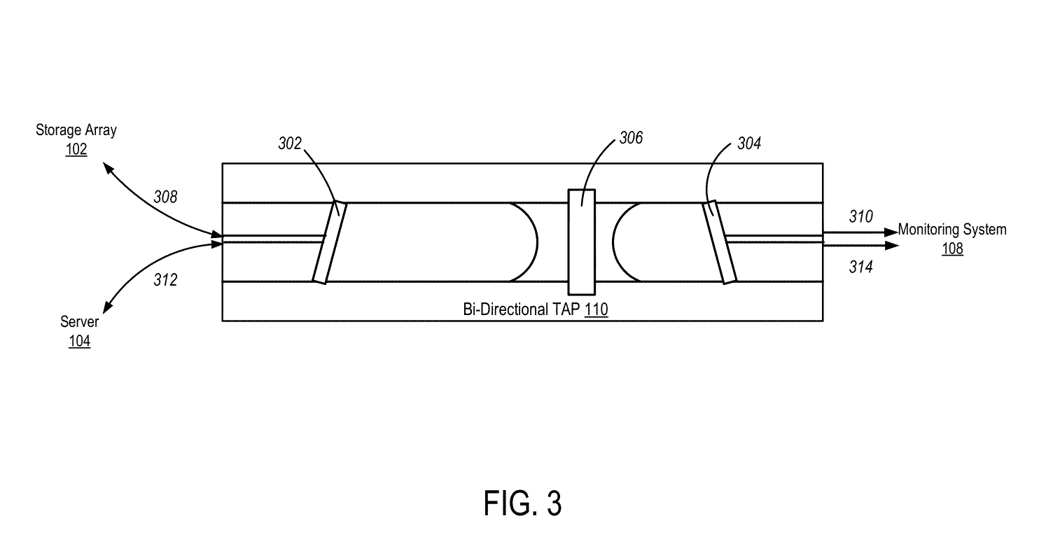

FIG. 3 illustrates a side view inside of the bi-directional TAP 110 according to one embodiment. The bi-directional TAP 110 includes collimator 302, collimator 304, and a thin film splitter (TFS) 306. The collimators 302 and 304 collimate the light (e.g., evenly distribute the light) of a signal towards a direction. The TFS 306 splits signals into two portions. The split may be approximately a 70/30 split or an 80/20 split. In this configuration, the highest power is reflected (e.g., 70% or 80%) and lowest power (e.g., 30% or 20%) is transmitted. The TFS 306 includes a dielectric multi-layer coating which assists in splitting signals close to theoretical values in a multimode environment.

When the bi-directional TAP 110 receives a downstream signal transmitted by the storage array 102 via a bi-directional connection 112B coupled to termination 202 of bi-directional fiber 308, the collimator 302 collimates the light of the signal towards the TFS 306. The TFS 306 splits the downstream signal into two portions. The first portion of the split downstream signal (e.g., 70% of the signal) is coupled to termination 204 via bi-directional fiber 312 which is connected to the server 104. The first portion is collimated by collimator 302 before it is collected by bi-directional fiber 312. The second portion of the split downstream signal is coupled to termination 206 via a uni-directional fiber 310 which is connected to the monitoring system 108. The second portion is collimated by collimator 304 before it is collected by bi-directional fiber 310.

When the bi-directional TAP 110 receives an upstream signal transmitted by the server 104 via the bi-directional fiber 312, the collimator 302 collimates the light of the signal towards the TFS 306. The TFS 306 splits the upstream signal into two portions. The first portion of the upstream signal (e.g., 70% of the signal) is coupled to the termination 202 via bi-directional fiber 308 for the storage array 102 to receive the first portion of the upstream signal. The first portion is collimated by collimator 302 before it is collected by bi-directional fiber 308. The second portion of the upstream signal is coupled to termination 206 via uni-directional fiber 314 which is connected to the monitoring system 108. The second portion is collimated by collimator 304 before it is collected by bi-directional fiber 314. Hence, the TFS 306 is splitting the downstream and upstream signals.

In one embodiment, multiple portions received by the monitoring system 108 are carried by a single uni-directional fiber. For example, instead of uni-directional fiber 310 carrying the downstream portion to the monitoring system 108 and uni-directional fiber 314 carrying the upstream portion, uni-directional fiber 310 could carry the upstream and downstream portions in other embodiments.

As can be seen in FIG. 3, the bi-directional TAP 110 is symmetrical along the optical axis (axis that the collimator 302 collimates light towards the TFS 306). For example, if the TAP 110 is rotated 180 degrees along the optical axis (x-axis), the upstream and downstream flows will be identical as well as the components on the live side (sides coupled to the storage array 102 and the server 104) and monitoring side (side coupled to monitoring system 108) are identical. The bi-directional TAP 110 is a reflective type of TAP since the upstream and downstream signals are reflected by the TAP 110 to their intended destination.

As a result of the bi-directional TAP 110 being symmetrical along the optical axis, the downstream and upstream signals will experience the same effects as a result of being reflected. For example, the downstream and upstream signals will experience approximately the same loss as a result of the signals being split. Additionally, because of the symmetry it makes the TAP 110 easier to manufacture since it only needs to be aligned in one direction. The other direction will align accordingly. For example, once the downstream alignment is completed, the upstream alignment will also be done since both streams are symmetric along the optical axis.

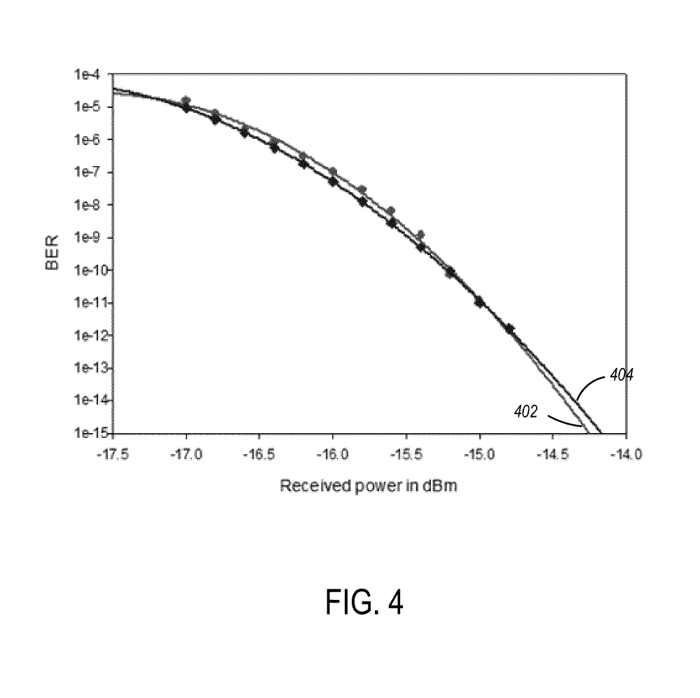

Results of insertion loss (IL) measurements of the bi-directional TAP 110 include the IL of the downstream signals being “1.7” dB for termination 202 and “5.7” dB for termination 206 with an isolation of “20” dB. Similarly the IL of the upstream signals was measured to be “1.6” dB for termination 204 and approximately “5.6” dB for the termination 206. FIG. 4 illustrates two plots of bit error rate (BER) rate as a function of received power at 10G Ethernet for the monitoring side of the bi-directional TAP 110 and for the monitoring side of a typical un-directional TAP. Plot 402 represents the performance of the bi-directional TAP 110 and plot 404 represents the performance of the uni-directional TAP. As can be seen, the BER performance of the bi-directional TAP 110 is similar to that of the uni-directional TAP. However, as described above, with the bi-directional TAP 110 the coupler density is reduced by half.

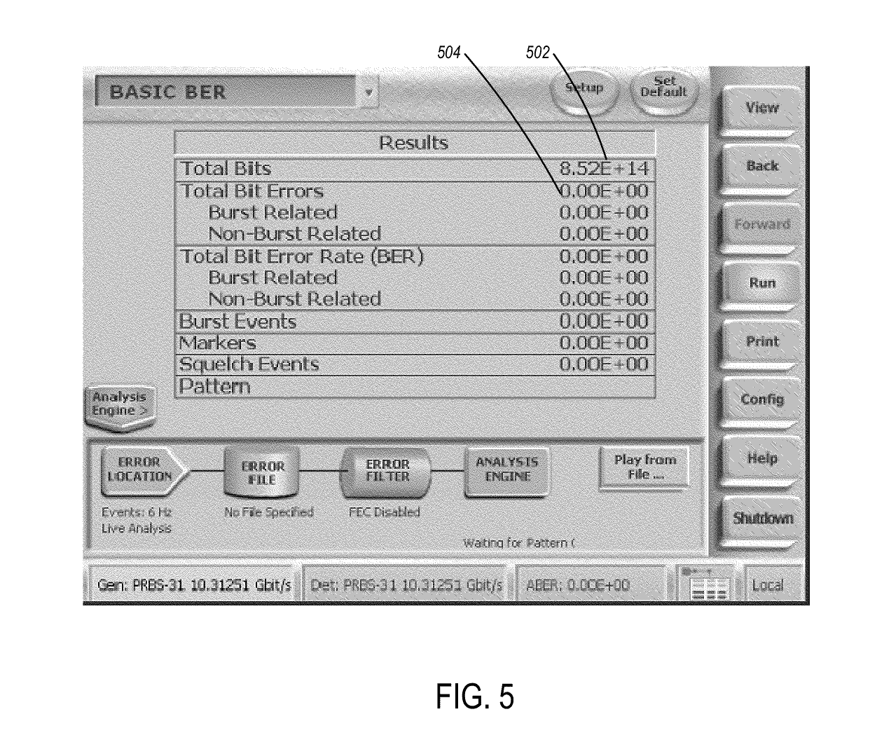

FIG. 5 illustrates the results of running the bi-directional TAP 110 for twenty two hours. As can be seen, after twenty two hours and “8.52E+14” total bits 502, there are no bit errors 504.

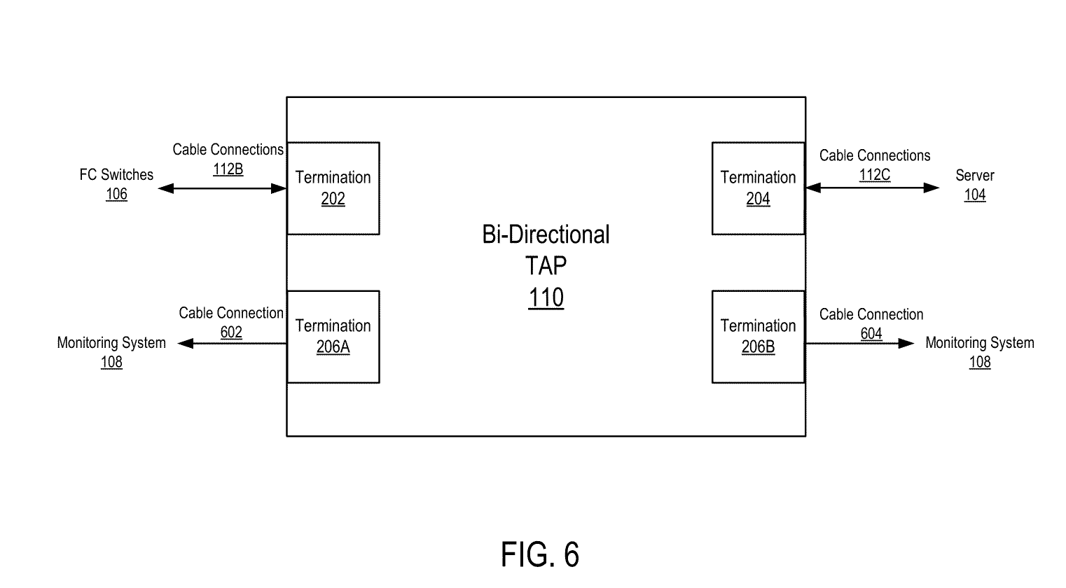

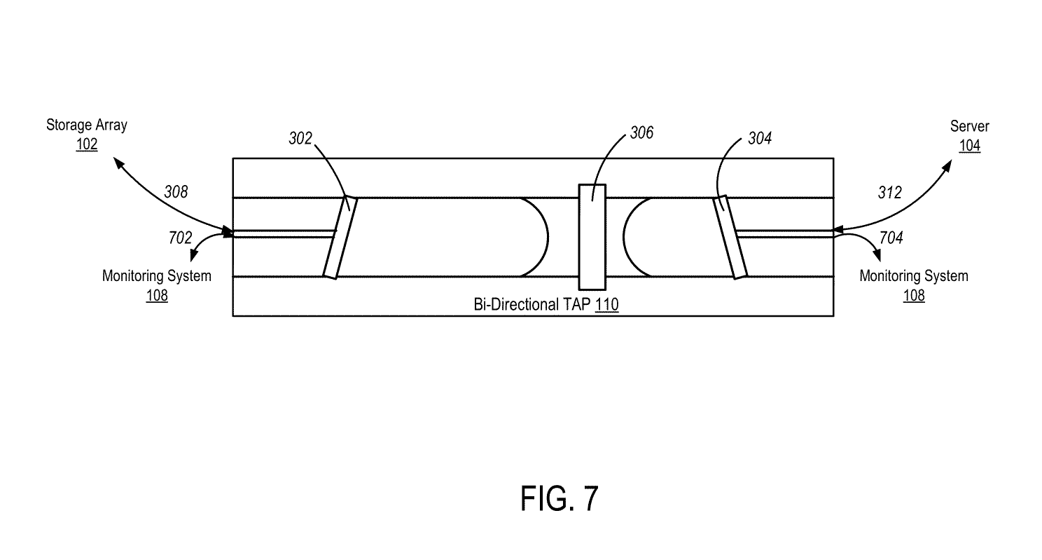

FIG. 6 illustrates the terminations of another embodiment of the bi-directional TAP 110. This is a transmitted type of bi-directional TAP because as shown in FIG. 7 upstream and downstream signals (e.g., 70% of the signals) are transmitted by the TAP 110 to their intended destinations instead of being reflected. Similar to embodiment of FIG. 2, the bi-directional TAP 110 here still includes terminations 202 and 204. However, the position of termination 204 is on the opposite side (on the side that originally included termination 206) making it a transmission type of TAP. Further, in this embodiment, instead of a duplex termination 206 as in FIG. 2, two terminations 206A and 206B are included on sides opposite to each other. Terminations 202 and 206A are on one side of the bi-directional TAP 110 and terminations 204 and 206B are on the opposite side (also referred to as the transmitted side). A uni-directional cable connection 602 from the cable connections 112D connects to termination 206A and another uni-directional cable connection 604 from the cable connections 112D connects to termination 206B.

FIG. 7 illustrates a side view inside of the bi-directional TAP 110 according to the embodiment of FIG. 6. Similar to the embodiment of FIG. 3, the bi-directional TAP 110 includes collimator 302, collimator 304, and the thin film splitter (TFS) 306. When the bi-directional TAP 110 receives a downstream signal transmitted by the storage array 102 via the bi-directional fiber 308 coupled to termination 202, the collimator 302 collimates the light of the signal towards the TFS 306 which splits the downstream signal. The first portion of the downstream signal (70% of the signal) is coupled to termination 204 via bi-directional fiber 312 which as described above is on the opposite side (or the transmitted side). The second portion of the split downstream signal is coupled to termination 206A via a uni-directional fiber 702 connected to the monitoring system 108. The first portion is collimated by collimator 304 before it is collected by bi-directional fiber 312 and the second portion is collimated by collimator 302 before it is collected by uni-directional fiber 702.

When the bi-directional TAP 110 receives an upstream signal transmitted by the server 104 via the bi-directional fiber 312, the collimator 304 collimates the light of the signal towards the TFS 306 which splits the upstream signal. The first portion of the upstream signal (e.g., 70% of the signal) is coupled to termination 202 via bi-directional fiber 308. The second portion of the upstream signal is coupled to termination 206B via a uni-directional fiber 704 connected to the monitoring system 108. The first portion is collimated by collimator 302 before it is collected by bi-directional fiber 308 and the second portion is collimated by collimator 304 before it is collected by uni-directional fiber 704.

Unlike the embodiment of FIGS. 2 and 3, in this embodiment, the bi-directional TAP 110 is not symmetrical along the optical axis because of the transmission design of the bi-directional TAP 110. As a result, the return loss could be higher on the monitoring side which may affect the quality of the monitoring signal especially in a data center.

### Additional Considerations

It is appreciated that the particular embodiment depicted in the figures represents but one choice of implementation. Other choices would be clear and equally feasible to those of skill in the art.

While the disclosure herein has been particularly shown and described with reference to a specific embodiment and various alternate embodiments, it will be understood by persons skilled in the relevant art that various changes in form and details can be made therein without departing from the spirit and scope of the disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience. This description should be read to include one or at least one and the singular also includes the plural unless it is obvious that it is meant otherwise.

Upon reading this disclosure, those of skill in the art will appreciate still additional alternative structural and functional designs for the embodiments described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by a bi-directional traffic access point (TAP), a first signal via a first multimode bi-directional fiber, the first signal transmitted by a first system and destined for a second system;
receiving, by the bi-directional traffic access point (TAP), a second signal via a second multimode bi-directional fiber, the second signal transmitted by the second system and destined for the first system;
splitting, by a splitter of the bi-directional TAP, the first signal into at least a first portion and a second portion;
splitting, by the splitter of the bi-directional TAP, the second signal into at least a first portion and a second portion;
outputting, by the bi-directional TAP, the first portion of the first signal to the second fiber for receipt by the second system;
outputting, by the bi-directional TAP, the first portion of the second signal to the first fiber for receipt by the first system; and
outputting, by the bi-directional TAP, the second portion of the first signal and the second portion of the second signal to a third system.

2. The method of claim 1, wherein the second portion of the first signal is output to a third fiber connected to the third system and the second portion of the second signal is output to a fourth fiber connected to the third system.

3. The method of claim 1, wherein splitting the first signal comprises:
collimating, by a collimator included in the bi-directional TAP, light of the first signal towards the splitter; and
splitting, by the splitter, the collimated light into the first and second portions of the first signal.

4. The method of claim 3, wherein the bi-directional TAP is symmetrical along an optical axis that the collimator collimates the lights towards.

5. The method of claim 1, wherein the splitter is a thin film splitter.

6. The method of claim 1, wherein the splitter includes a dielectric multi-layer coating.

7. The method of claim 1, wherein the third system is a signal monitoring system.

8. The method of claim 1, wherein the first portion of the first signal is approximately 70% of the first signal and the second portion of the first signal is approximately 30% of the first signal.

9. The method of claim 1, wherein the first portion of the first signal is approximately 80% of the first signal and the second portion of the first signal is approximately 20% of the first signal.

10. A bi-directional traffic access point (TAP) comprising:
a first termination configured to receive a first signal via a first multimode bi-directional fiber, the first signal transmitted by a first system and destined for a second system;
a second termination configured to receive a second signal via a second multimode bi-directional fiber, the second signal transmitted by the second system and destined for the first system; and
a splitter configured to:
split the first signal into at least a first portion and a second portion; and
split the second signal into at least a first portion and a second portion;
wherein the first termination is further configured to output the first portion of the second signal to the first fiber for receipt by the first system;
wherein the second termination is further configured to output the first portion of the first signal to the second fiber for receipt by the second system; and
wherein the second portion of the first signal and the second portion of the second signal are output to a third system.

11. The bi-directional TAP of claim 10, wherein the first portion of the first signal has a higher power level than the second portion of the first signal and the first portion of the second signal has a higher power level than the second portion of the second signal.

12. The bi-directional TAP of claim 10, further comprising:
a first collimator configured to:
collimate light of the first signal towards the splitter for the splitting of the first signal;
collimate light the second signal towards the splitter for the splitting of the second signal; and
collimate the first portion of the second signal and the second portion of the second signal; and
a second collimator configured to collimate the second portion of the first signal and the second portion of the second signal.

13. The bi-directional TAP of claim 10, wherein the bi-directional TAP is symmetrical along an optical axis and the splitter is a thin film splitter.

14. The bi-directional TAP of claim 10, wherein the bi-directional TAP is used for data monitoring and wherein the first signal and the second signal are alternating current signals.

15. The bi-directional TAP of claim 10, wherein the bi-directional TAP is used for power monitoring.

16. The bi-directional TAP of claim 10, further comprising:
a third termination configured to output the second portion of the first signal to a third fiber connected to the third system and the second portion of the second signal to a fourth fiber connected to the third system.

17. The bi-directional TAP of claim 16, wherein the first termination and the second termination are positioned on a first side of the bi-directional TAP and the third termination is positioned on a second side of the bi-directional TAP opposite to the first side.

18. The bi-directional TAP of claim 10, further comprising:
a third termination configured to output the second portion of the first signal to the third system; and
a fourth termination configured to output the second portion of the second signal to the third system.

19. The bi-directional TAP of claim 18, wherein the first termination and the third termination are positioned on a first side of the bi-directional TAP and the second termination and the fourth termination are positioned on a second side of the bi-directional TAP opposite to the first side.

20. The bi-directional TAP of claim 10, wherein the first portion of the first signal is approximately 70% or 80% of the first signal and the second portion of the first signal is approximately 30% or 20% of the first signal.
